(19) United States
(12) Patent Application Publication
(10) Pub. No.: US 2008/0092154 A1
(43) Pub. Date: Apr. 17, 2008

(54) Pay program providing system and television broadcast reception apparatus

(75) Inventor: Itaru Hogyoku, Kashihara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/907,452

(22) Filed: Oct. 12, 2007

(30) Foreign Application Priority Data
Oct. 17, 2006 (JP) 2006-282153

(51) Int. Cl. H04N 7/16

(52) U.S. Cl. 725/1

(57) ABSTRACT

A pay program providing system has: a television broadcast reception apparatus receiving video data of a pay program and address data for accessing a predetermined communication server, and displaying the address data on a screen; a communication terminal acquiring the address data displayed on the screen and accessing the communication server; and the communication server, when accessed, communicating with the communication terminal. The television broadcast reception apparatus displays the video data only when predetermined key data is entered. The communication terminal transmits the ID data thereof to the communication server; the communication server transmits the key data to the communication terminal or the like; and the communication terminal acquires the key data and outputs it to the television broadcast reception apparatus. In this way, it is possible to provide a pay program providing system that can quickly enable subscribers to view pay broadcast at their request to do so but that nevertheless allows program providers to identify subscribers easily.

This nonprovisional application claims priority under 35 U.S.C. §119(a) on Patent Application No. 2006-282153 filed in Japan on Oct. 17, 2006, the entire contents of which are hereby incorporated by reference.

### BACKGROUND OF THE INVENTION

1. Field of the Invention

The present invention relates to a pay program providing system for providing pay programs for subscribers, and also relates to a television broadcast reception apparatus.

2. Description of Related Art

Conventionally, some television (TV) broadcast programs are provided in the form of pay programs. To view such a pay program, a subscriber (a person who intends to view it) is typically required to sign a subscription contract with the provider of the program beforehand. Thus, only subscribers who have signed such a contract can descramble and enjoy the provided video contents.

There are different forms of subscription contracts between a program provider and a subscriber: for example, a subscriber is required to pay a fixed charge per month to be able to view programs for that month; or charges are set on a program-by-program basis beforehand so that a subscriber can view a particular program by paying the corresponding charge.

The conventional methods mentioned above presuppose that a subscriber signs a contract with a program provider beforehand; thus, unless a subscriber signs a contract with a program provider beforehand, he encounters difficulty in using a pay broadcast service when he feels like using it. Specifically, if a person who has not signed a contract notices that a pay program that he wants to view will be broadcast shortly (for example, 10 minutes later), quite inconveniently, he cannot sign one beforehand in time for being able to view the program.

Apparently, this inconvenience can be overcome, for example, by enabling all subscribers to view pay broadcast without bothering to sign a contract, and collecting the charges afterwards. This, however, may make it difficult for a program provider to identify subscribers and collect charges. Thus, it is common thought, among service providers, to identify subscribers and secure ways to collect charges by some means before enabling them to view pay broadcast.

### SUMMARY OF THE INVENTION

In view of the conventionally experienced inconveniences mentioned above, it is an object of the present invention to provide a pay program providing system that can quickly enable subscribers to view pay broadcast at their request to do so but that nevertheless allows program providers to identify subscribers easily. It is also an object of the present invention to provide a television broadcast reception apparatus suitable for such a pay program providing system.

To achieve the above objects, according to one aspect (a first design) of the present invention, a pay program providing system is provided with: a television broadcast reception apparatus that receives video data of a pay program and address data for accessing a predetermined communication server, and that displays the address data on a screen; a communication terminal that acquires the address data displayed on the screen and accesses the communication server; and the communication server that, when accessed, communicates with the communication terminal. The pay program providing system makes the television broadcast reception apparatus display the video data of the pay program on the screen. Here, the television broadcast reception apparatus displays the video data only when predetermined key data is entered. The communication terminal transmits the ID data thereof to the communication server; the communication server transmits the key data to the communication terminal that has transmitted the ID data thereof or to a communication device that the communication terminal can access; and the communication terminal acquires the key data and outputs it to the television broadcast reception apparatus.

With this design, the television broadcast reception apparatus displays the video data of the pay program on the screen only when the predetermined key data is entered. Thus, by properly managing the key data, viewing restrictions can be placed on the pay program. Moreover, the communication server transmits the key data to the communication terminal that has transmitted the ID data thereof or to a communication device that the communication terminal can access. Thus, by acquiring the ID data, the administrator of the communication server can easily identify or otherwise manage subscribers.

Moreover, the communication server has only to transmit the key data to the communication terminal that has transmitted the ID data thereof, or the like. Thus, the key data can be transmitted comparatively quickly. Accordingly, the key data needed to view the pay program can be sent to a subscriber quickly. In this way, it is possible to realize a pay program providing system that can quickly enable subscribers to view pay broadcast at their request to do so but that nevertheless allows program providers to identify subscribers easily.

Incidentally, the “communication device that the communication terminal can access” is, for example, a mail server or the like that serves the communication terminal (such as a mobile phone).

According to another aspect (a second design) of the present invention, a pay program providing system is provided with: a television broadcast reception apparatus that receives video data of a pay program having undergone scrambling and address data for accessing a predetermined communication server, and that displays the address data on a screen; a communication terminal that acquires the address data displayed on the screen and accesses the communication server; and the communication server that, when accessed, communicates with the communication terminal. The pay program providing system makes the television broadcast reception apparatus display the video data of the pay program on the screen. Here, the scrambling can be descrambled by descrambling using predetermined key data, and the television broadcast reception apparatus performs the descrambling and displays the video data only when the key data is entered. The communication terminal transmits the ID data thereof to the communication server; the communication server transmits the key data to the communication terminal that has transmitted the ID data thereof or to a communication device that the communication terminal can access; and the communication terminal acquires the key data and outputs it to the television broadcast reception apparatus.

With this design, the television broadcast reception apparatus descrambles the scrambling done on the video data of the pay program only when the predetermined key data is entered. Thus, by properly managing the key data, viewing restrictions can be placed on the pay program. Moreover, the communication server transmits the key data to the communication terminal that has transmitted the ID data thereof or to a communication device that the communication terminal can access. Thus, by acquiring the ID data, the administrator of the communication server can easily identify or otherwise manage subscribers.

Moreover, the communication server has only to transmit the key data to the communication terminal that has transmitted the ID data thereof, or the like. Thus, the key data can be transmitted comparatively quickly. Accordingly, the key data needed to view the pay program can be sent to a subscriber quickly. In this way, it is possible to realize a pay program providing system that can quickly enable subscribers to view pay broadcast at their request to do so but that nevertheless allows program providers to identify subscribers easily.

According to another aspect (a third design) of the present invention, in the above design, the television broadcast reception apparatus may be provided with a QR code generating portion that generates, based on the received address data, a QR code (a registered trademark of Denso Wave Incorporated) into which the contents of the address data are encoded, so that television broadcast reception apparatus displays the QR code as the address data on the screen.

With this design, the television broadcast reception apparatus displays on the screen the QR code into which the contents of the address data are encoded. Thus, by use of a mobile terminal provided with photographing means and means for decoding QR codes, it is possible to acquire the contents of the address data easily.

According to another aspect (a fourth design) of the present invention, in the above design, the television broadcast reception apparatus may also receive program identifying data that indicates the type of the pay program, so that the QR code generating portion generates, based on the received address data and the program identifying data, a QR code into which the contents of the address data and the program identifying data are encoded.

With this design, by way of the communication terminal, the communication server can easily be informed what pay program a subscriber intends to view. Thus, the communication server can provide data related to the pay program that the subscriber intends to view.

According to another aspect (a fifth design) of the present invention, in the above design, the communication terminal may be provided with a data acquiring portion that photographs the QR code displayed on the screen and acquires the data encoded into the QR code. With this design, the communication terminal can easily acquire data held in the television broadcast reception apparatus.

According to another aspect (a sixth design) of the present invention, in the above design, the television broadcast reception apparatus may also receive chargeability identifying data that indicates whether or not the program is a pay program, so that television broadcast reception apparatus checks whether or not the program is a pay program based on the chargeability identifying data and, only if the program is a pay program, displays the address data on the screen.

With this design, when what is being received is not a pay program (as when it is a charge-free program), the display of the address data on the screen can be omitted. Thus, the processing that the television broadcast reception apparatus needs to perform can be alleviated.

According to another aspect (a seventh design) of the present invention, in the above design, the television broadcast reception apparatus may be further provided with a notification image display portion that the television broadcast reception apparatus, on finding the program to be a pay program, makes display a notification image on a screen to notify a subscriber that the program is a pay program. With this design, a subscriber can more surely be made aware that the program that he intends to view is a pay program.

According to another aspect (an eighths design) of the present invention, in the above design, the television broadcast reception apparatus may be further provided with a notification image storage portion that stores a plurality of types of the notification image, so that the notification image display portion displays one of the plurality of types of the notification image on the screen. With this design, for example, one of different notification images can be displayed according to the type of the pay program, and thus a subscriber can be provided with more relevant data.

According to another aspect (a ninth design) of the present invention, in the above design, the television broadcast reception apparatus may also receive notification image selection data that indicates which of the plurality of types of the notification image to display, so that the notification image display portion decides which of the types of the notification image to display on the screen based on the notification image selection data. With this design, a subscriber can easily be provided with relevant data according to the type of the pay program.

According to another aspect (a tenth design) of the present invention, in the above design, the television broadcast reception apparatus may also receive data of the notification image, so that the notification image display portion displays the notification image on the screen. With this design, the television broadcast reception apparatus receives the data of the notification image itself. Thus, a subscriber can easily be provided with highly relevant data according to the pay program.

According to another aspect (an eleventh design) of the present invention, in the above design, the communication terminal may transmit the program identifying data to the communication server, so that the communication server transmits predetermined transmission data stored previously therein to the communication terminal according to the program identifying data received therefrom. With this design, for example, as the transmission data, the contents of pay programs, or the like, can be prepared previously so that they can easily be recognized by a subscriber by way of the communication terminal.

According to another aspect (a twelfth design) of the present invention, in the above design, more specifically, the transmission data may contain data for notifying a subscriber of the fact that the program is a pay program along with the title and the viewing charge of the pay program.

According to another aspect (a thirteenth design) of the present invention, in the above design, more specifically, the transmission data may contain data for notifying a subscriber that the program is a pay program and that the viewing charge of the pay program can be paid by the charge collection service for the communication terminal.

According to another aspect (a fourteenth design) of the present invention, in the above design, the communication terminal may transmit the program identifying data to the communication server, so that the communication server transmits a program stored previously therein to the communication terminal according to the program identifying data received therefrom, the program being for making the communication terminal display a predetermined image on a screen. With this design, the communication server can provide the communication terminal with data according to the type of the pay program.

According to another aspect (a fifteenth design) of the present invention, in the above design, the communication terminal and the television broadcast reception apparatus may be provided with infrared communication means for communicating with each other by infrared communication, so that the communication terminal transmits the key data to the television broadcast reception apparatus by the infrared communication means. With this design, the key data can easily be transferred to the television broadcast reception apparatus by infrared communication.

According to another aspect (a sixteenth design) of the present invention, in the above design, the communication server may encrypt the key data by encryption that can be decrypted by predetermined decryption, so that the television broadcast reception apparatus acquires the key data by performing the decryption.

According to another aspect (a seventeenth design) of the present invention, a method for use in the pay program providing system of any of the designs described above to provide the pay program includes: a first step in which the television broadcast reception apparatus receives the address data and displays the address data on the screen; a second step in which the communication terminal acquires an image representing the address data displayed on the screen and accesses the communication server; a third step in which the communication terminal transmits the ID data thereof to the communication server; a fourth step in which the communication server transmits the key data to the communication terminal that has transmitted the ID data thereof or to a commutation device that the communication terminal can access; a fifth step in which the communication terminal acquires the key data and outputs the key data to the television broadcast reception apparatus; and a sixth step in which the television broadcast reception apparatus acquires the key data. With this method, by use of the pay program providing system of any of the first to sixteenth designs described above, it is possible to realize a service that can meet the needs of both subscribers and pay program providers as much as possible.

According to another aspect (an eighteenth design) of the present invention, a pay program providing system is provided with: a television broadcast station that broadcasts video data of a pay program and address data for accessing a predetermined communication server; a television broadcast reception apparatus that receives the video data and the address data and displays the address data on a screen; a communication terminal that acquires the address data displayed on the screen and accesses the communication server; and the communication server that, when accessed, communicates with the communication terminal. The pay program providing system makes the television broadcast reception apparatus display the video data of the pay program on the screen. Here, the television broadcast reception apparatus displays the video data only when predetermined key data is entered. The communication terminal transmits the ID data thereof to the communication server; the communication server transmits the key data to the communication terminal that has transmitted the ID data thereof or to a communication device that the communication terminal can access; and the communication terminal acquires the key data and outputs it to the television broadcast reception apparatus.

According to another aspect (a nineteenth design) of the present invention, a pay program providing system is provided with: a television broadcast station that broadcasts video data of a pay program having undergone scrambling and address data for accessing a predetermined communication server; a television broadcast reception apparatus that receives the video data and the address data and displays the address data on a screen; a communication terminal that acquires the address data displayed on the screen and accesses the communication server; and the communication server that, when accessed, communicates with the communication terminal. The pay program providing system makes the television broadcast reception apparatus display the video data of the pay program on the screen. Here, the scrambling can be descrambled by descrambling using predetermined key data, and the television broadcast reception apparatus performs the descrambling and displays the video data when the key data is entered. The communication terminal transmits ID data thereof to the communication server; the communication server transmits the key data to the communication terminal that has transmitted the ID data thereof or to a communication device that the communication terminal can access; and the communication terminal acquires the key data and outputs it to the television broadcast reception apparatus.

According to another aspect (a twentieth design) of the present invention, a method for use in the pay program providing system of either of the designs described above to provide the pay program includes: a first step in which the television broadcast station broadcasts the video data of the pay program and the address data; a second step in which the television broadcast reception apparatus receives the address data and displays the address data on the screen; a third step in which the communication terminal acquires an image representing the address data displayed on the screen and accesses the communication server; a fourth step in which the communication terminal transmits the ID data thereof to the communication server; a fifth step in which the communication server transmits the key data to the communication terminal that has transmitted the ID data thereof or to a commutation device that the communication terminal can access; a sixth step in which the communication terminal acquires the key data and outputs it to the television broadcast reception apparatus; and a seventh step in which the television broadcast reception apparatus acquires the key data. With this method, by use of the pay program providing system of either of the eighteenth and nineteenth designs described above, it is possible to realize a service that can meet the needs of both subscribers and pay program providers as much as possible.

According to another aspect (a twenty-first design) of the present invention, a television broadcast reception apparatus that receives television broadcast containing video data of a pay program, address data for accessing a predetermined communication server, and chargeability identifying data indicating whether or not the program is a pay program, and that displays the video data on a screen is provided with: a chargeability checking portion that checks, based on the chargeability identifying data, whether or not the program is a pay program; a QR code generating portion that generates, based on the address data, a QR code into which the contents of the address data are encoded; and a QR code display portion that displays the QR code on the screen when the chargeability checking portion finds the program to be a pay program.

According to another aspect (a twenty-second design) of the present invention, in the above design, there may further be provided a notification image display portion that the television broadcast reception apparatus, on finding the program to be a pay program, makes display a notification image on a screen to notify a subscriber that the program is a pay program.

According to another aspect (a twenty-third design) of the present invention, in the above design, there may further be provided a notification image storage portion that stores a plurality of types of the notification image, so that the notification image display portion displays one of the plurality of types of the notification image on the screen.

According to another aspect (a twenty-fourth design) of the present invention, the television broadcast reception apparatus of the twenty-third design described above may also receive notification image selection data that indicates which of the plurality of types of the notification image to display, so that the notification image display portion decides which of the types of the notification image to display on the screen based on the notification image selection data.

According to another aspect (a twenty-fifth design) of the present invention, the television broadcast reception apparatus of the above design may also receive data of the notification image, so that the notification image display portion displays the notification image on the screen.

With one of the designs described above, it is possible to realize a television broadcast reception apparatus that is suitable for use in one of the pay program providing systems described previously.

### BRIEF DESCRIPTION OF THE DRAWINGS

These and other objects and features of the present invention will be apparent from the following detailed description of preferred embodiments thereof taken in conjunction with the accompanying drawings, in which

FIG. 1 is a diagram showing an outline of the configuration of a pay program providing system embodying the invention;

FIG. 2 is a diagram showing an outline of the structure of stream data in an embodiment, for example Embodiment 1, of the invention;

FIG. 3 is a diagram showing the configuration of a television broadcast reception apparatus in an embodiment of the invention;

FIG. 4 is a diagram showing the configuration of a mobile phone in an embodiment of the invention;

FIG. 5 is a diagram showing the configuration of a communication server in an embodiment of the invention;

FIG. 6 is a flow chart of the processing performed in a pay program providing system embodying the invention;

FIG. 7 is a diagram showing a screen display on a television broadcast reception apparatus in an embodiment of the invention;

FIG. 8 is a diagram showing a screen display on a mobile phone in an embodiment of the invention;

FIG. 9 is a diagram showing another screen display on a mobile phone in an embodiment of the invention;

FIG. 10 is a diagram showing another screen display on a mobile phone in an embodiment of the invention;

FIG. 11 is a diagram showing another screen display on a mobile phone in an embodiment of the invention;

FIG. 12 is a diagram showing an outline of the structure of stream data in Embodiment 2 of the invention;

FIG. 13 is a flow chart of the processing related to the encryption of key data in an embodiment of the invention;

FIG. 14 is a diagram illustrating the encryption of key data in an embodiment of the invention; and

FIG. 15 is a diagram illustrating what is performed in an embodiment of the invention.

### DETAILED DESCRIPTION OF PREFERRED EMBODIMENTS

Hereinafter, the present invention will be described by way of a few embodiments, namely Embodiments 1 to 3.

### Embodiment 1

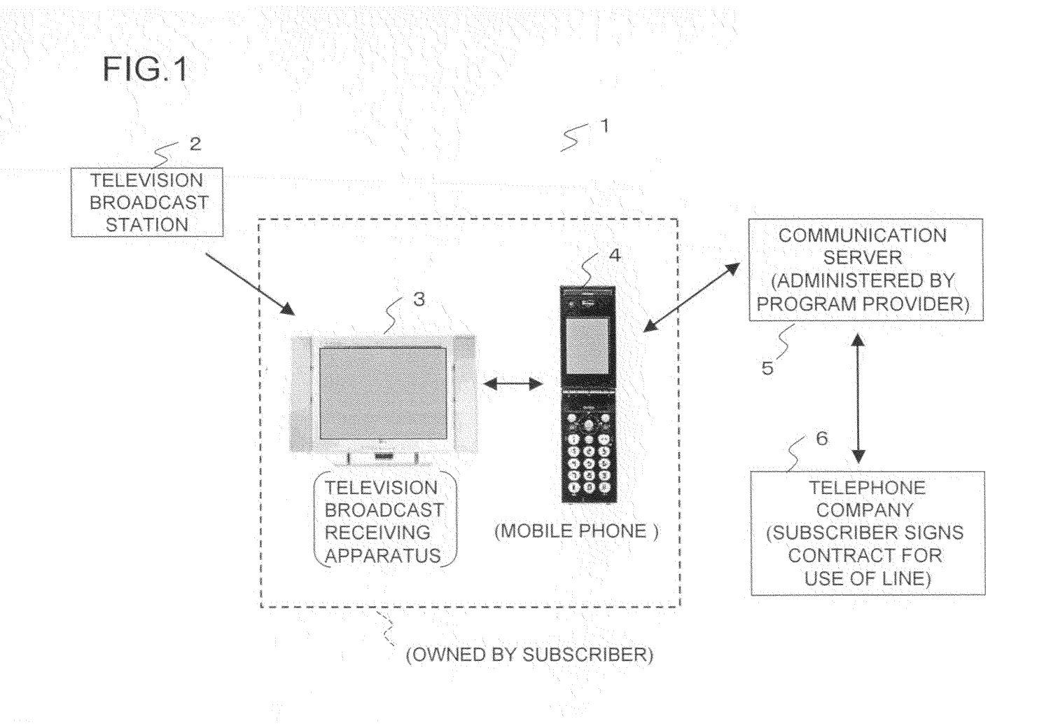

As a first embodiment of the present invention, a pay program providing system will be described below. An outline of the configuration of the pay program providing system is shown in FIG. 1. As shown there, the pay program providing system 1 includes a television broadcast station 2, a television broadcast reception apparatus 3, a mobile phone 4, a communication server 5, and a telephone company 6.

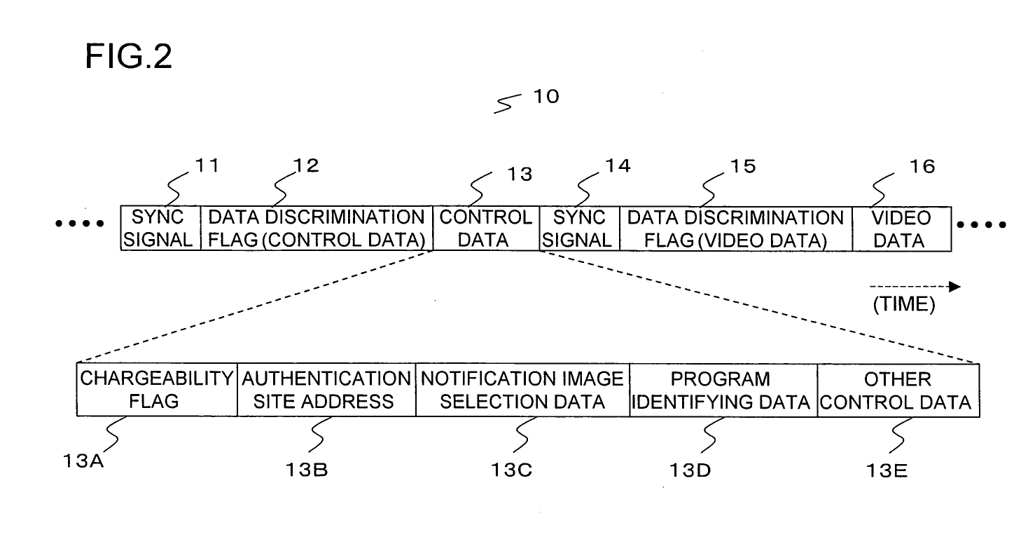

First, the television broadcast station 2 will be described. The television broadcast station 2 broadcasts, for example by using an RF (radio-frequency) signal, a data stream containing data (video data etc.) relating to a program produced by a program provider. Now, the structure of the data stream will be described with reference to FIG. 2.

As shown in FIG. 2, the data stream 10 is composed of a sync signal 11, a data identifying flag 12, control data 13, a sync signal 14, a data identifying flag 15, and video data 16. The sync signals 11 and 14 each mark the beginning of a sequence of data. The data identifying flag 12 indicates that control data 13 follows, and the data identifying flag 15 indicates that video data 16 follows.

The control data 13 contains various items of data related to control. In particular, when a pay program is being broadcast, it contains, as shown in FIG. 2, a chargeability flag 13A, an authentication site address 13B, notification image selection data 13C, program identifying data 13D, and other control data 13E.

The chargeability flag 13A indicates whether or not the program being broadcast is a pay program. The authentication site address 13B indicates the address of the authentication site (Web page) that a subscriber needs to access to be authenticated to view the pay program. This authentication site is provided by the communication server 5. The notification image selection data 13C is used to display a guide of the pay program on the television broadcast reception apparatus 3, and differs depending on, for example, the viewing charge set for the pay program. The program identifying data 13D is data by which the type of the program being broadcast is recognized, and is used by the communication server 5 to check the type of the program, as will be described later.

The video data 16 is the data of the video that is the contents of the program. With a pay program, the video data 16 has undergone scrambling so that, unless the scrambling is descrambled, the program cannot be viewed normally. Although not illustrated, audio data accompanies the video data 16 so that the audio contained in the program can be outputted on the television broadcast reception apparatus 3.

Even if the television broadcast is analog, the above control data can be transmitted by superimposing a data signal on the scan line during the vertical blanking period. Thus, whether by digital or analog broadcast, it is possible to broadcast what can be regarded as the data stream 10 described above.

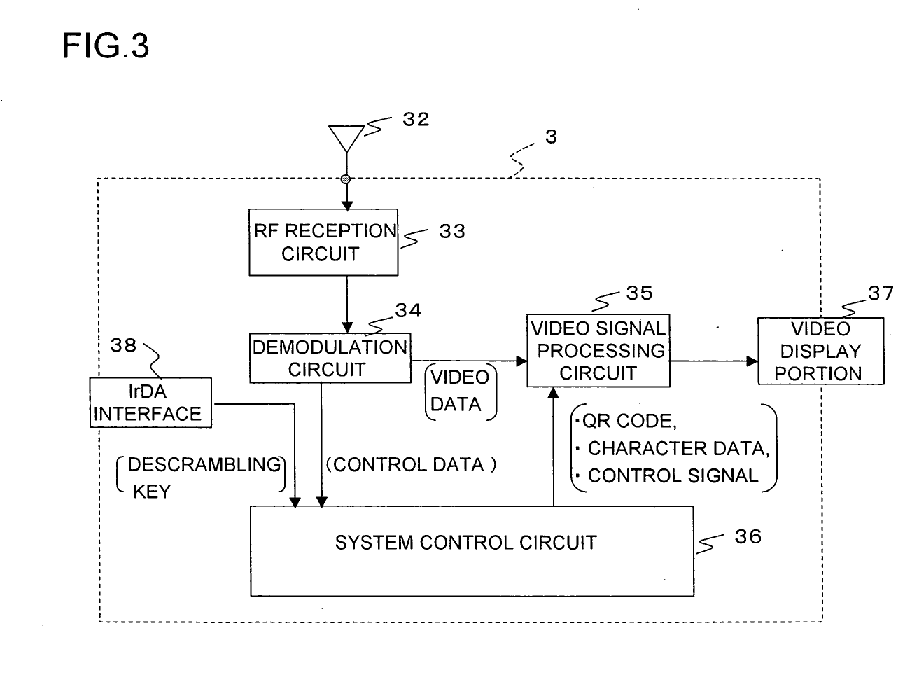

Next, the television broadcast reception apparatus (hereinafter referred to simply as the “reception apparatus”) 3 will be described. The reception apparatus 3 receives television broadcast transmitted from the television broadcast station 2, and displays the contents of a broadcast program on a screen. The configuration of the reception apparatus 3 will be described below with reference to FIG. 3.

As shown in FIG. 3, the reception apparatus 3 is composed of an antenna 32, an RF reception circuit 33, a demodulation circuit 34, a video signal processing circuit 35, a system control circuit 36, a video display portion 37, an IrDA interface 38, and other blocks.

The RF reception circuit 33 receives an RF signal (television broadcast signal) captured by the antenna 32, and transfers it to the circuit in the succeeding stage. The RF reception circuit 33 incorporates a tuner circuit, so that only the signal of the channel selected by the subscriber is passed on.

The demodulation circuit 34 receives the signal transferred from the RF reception circuit 33, and extracts from it the video data 16 and the control data 13. The extraction here is performed with reference to the sync signals and data identifying flags contained in the data stream described above. Then, the video data 16 is transferred to the video signal processing circuit 35 in the succeeding stage, and the control data 13 is transferred to the system control circuit 36.

The video signal processing circuit 35 receives the video data from the demodulation circuit 34 or from the system control circuit 36, and makes, based on it, the video display portion 37 display video. The video signal processing circuit 35 incorporates a descrambling circuit so that, when key data, which will be described later, is entered, the video signal processing circuit 35 performs descrambling using it on video data having undergone scrambling. The video display portion 37 is provided with a video display device such as a CRT or liquid crystal display.

The system control circuit 36 receives the control data, and performs, based on it, various kinds of control. In particular, when the television broadcast of a pay program (which is recognized as such based on the state of the chargeability flag 13A) is being received, the system control circuit 36 receives the authentication site address 13B and the program identifying data 13D, and generates, based on them, a QR code (a trademark of Denso Wave Incorporated, which applies throughout the present specification) into which their contents are encoded, then transferring the QR code to the video signal processing circuit 35. The processing here is unnecessary for the reception of a charge-free program; thus, it may be performed only when what is being received is a pay program based on the chargeability flag 13A.

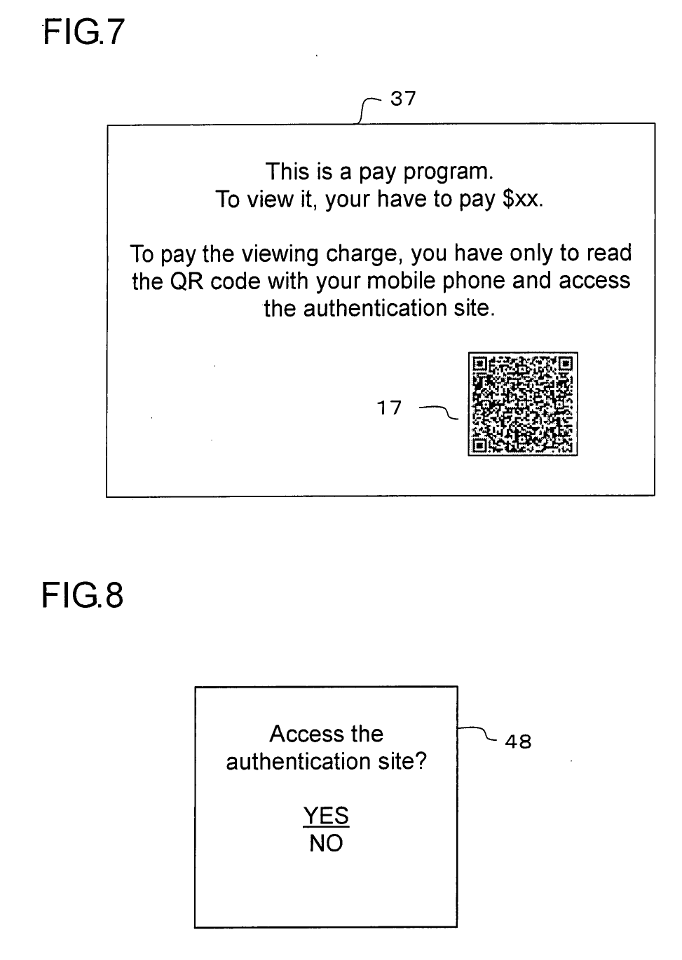

The system control circuit stores a plurality of types of image, as the one shown in FIG. 7, as guides to pay programs. The purpose of storing a plurality of types of image here is to cope with different classes of pay programs for which different charges etc. are set.

The IrDA interface 38 performs infrared communication (IrDA communication) with the mobile phone 4 or the like. As will be described later, by way of the IrDA interface, the reception apparatus 3 can receive from the mobile phone 4 the key data with which to descramble the scrambling.

Configured as described above, the reception apparatus 3 operates as follows: when the television broadcast of an ordinary (charge-free) program is being received, the reception apparatus 3 makes the video display portion 37 display the broadcast video; when the television broadcast of a pay program is being received, the reception apparatus 3 makes the video display portion 37 display the broadcast video along with the QR code generated by the system control circuit 36.

Here, the QR code may be displayed superposed on the broadcast video, or the display of the QR code and the display of the broadcast video may be switched, for example, at the subscriber's command.

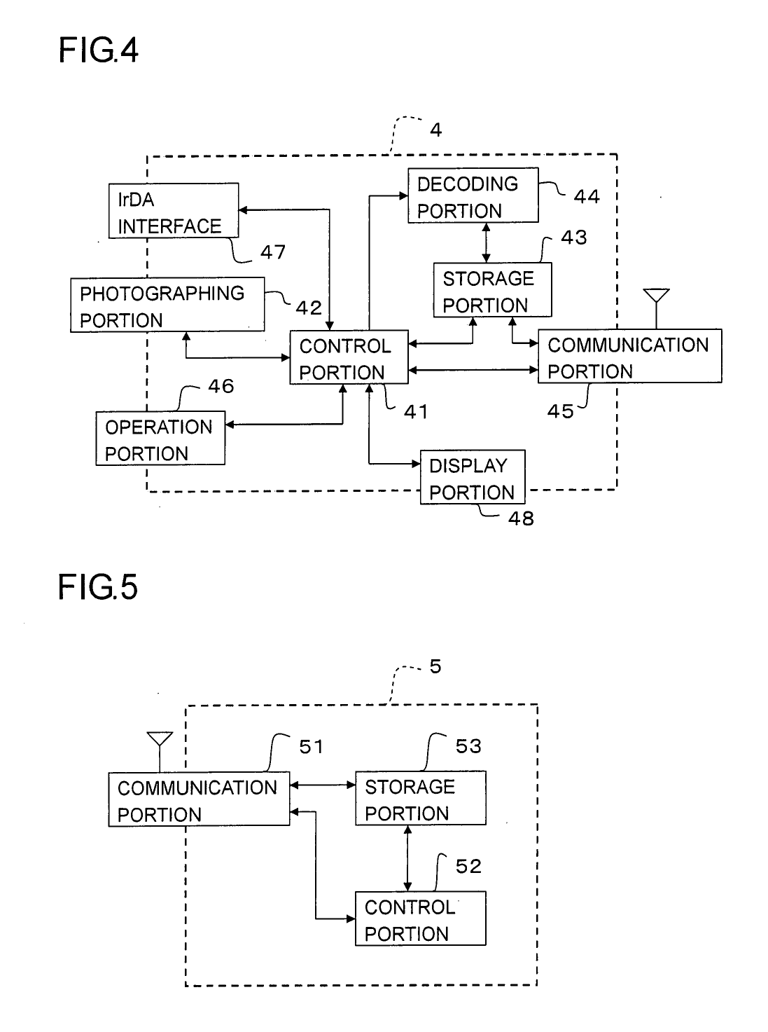

Next, the mobile phone 4 will be described. As shown in FIG. 4, the mobile phone 4 here includes a control portion 41, a photographing portion 42, a storage portion 43, a decoding portion 44, a communication portion 45, an operation portion 46, and IrDA interface 47, a display portion 48, and other blocks.

The control portion 41 incorporates a microcomputer or the like, and controls the different blocks in the mobile phone 4. The photographing portion 42 incorporates an image sensor such as a CCD or CMOS, and acquires the data of an optical image formed through a lens. This enables the mobile phone 4 to acquire the data of the QR code displayed on the video display portion of the reception apparatus 3.

The storage portion 43 is built with a RAM or the like, and stores the image data acquired by the photographing portion 42, the various kinds of data received by way of the communication portion 45, and the ID data etc. of the mobile phone 4 itself. The ID data here contains the data by which the mobile phone and its owner can be identified and the data by which the telephone company with which the owner of the mobile phone 4 is in a contract for use of a communication line can be identified. The decoding portion 44 decodes the QR code stored in the storage portion 43, and returns the address data etc. thereby acquired to the storage portion 43.

The communication portion 45 is provided with an antenna, and performs wireless communication (exchange of RF signals) with the communication server 5 and other communication devices. The operation portion 46 is provided with, for examples, key switches, and, as these are operated by the subscriber, the operation portion 46 acquires the data of various instructions from the subscriber. The IrDA interface 47 performs infrared communication (IrDA communication), and communicates with the IrDA interface 38 in the reception apparatus 3. The display portion 48 is provided with a display to achieve various kinds of screen display.

Configured as described above, the mobile phone 4 can acquire the data of the QR code displayed by the reception apparatus 3 and perform communication with the communication server 5 to which the mobile phone 4 can connect by accessing the address represented by the QR code.

Next, the communication server 5 will be described. As shown in FIG. 5, the communication server 5 includes a communication portion 51, a control portion 52, a storage portion 53, and other blocks. The communication server 5 is managed by, for example, a provider of pay programs. The communication portion 51 performs wireless communication (exchange of RF signals) with the mobile phone 4 and other communication devices. The control portion 52 controls the different blocks in the communication server 5.

In the storage portion 53, there are previously stored, among others: the data by which, when the communication server 5 is accessed by the mobile phone 4 or the like, the communication server 5 presents the authentication site at which subscribers can be authenticated to view pay programs; the data related to the contents and viewing charges of pay programs; and the key data with which the scrambling done on the video data of pay programs can be descrambled. Moreover, when the mobile phone 4 transmits its ID data or other data, the storage portion 53 stores it.

With the telephone company 6, the owner of the mobile phone 4 has signed a contract for the use of a mobile phone line etc. beforehand. Thus, the telephone company 6, in exchange for providing the owner with a mobile communication service etc., collects communication charges, for example, by obliging the owner to deposit them to the company's bank account.

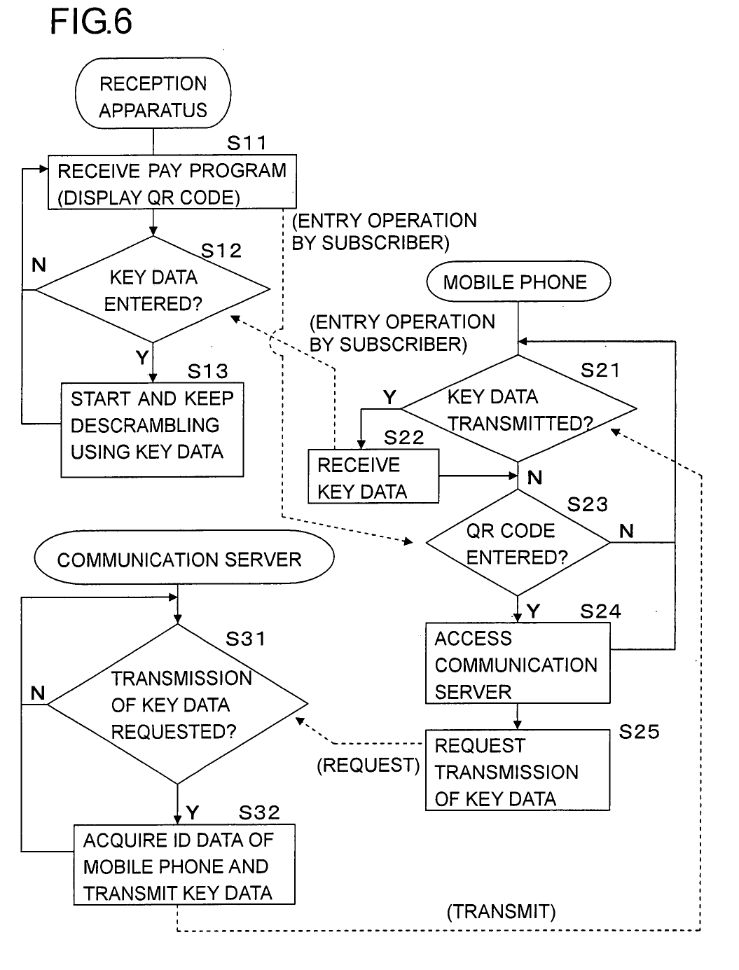

Next, the flow of processing performed to enable a subscriber to view a pay program in the pay program providing system 1 described above will be described with reference to the flowchart in FIG. 6.

As described above, when a pay program is received, the reception apparatus 3 displays, on the screen, the acquired video data (having undergone scrambling) and the QR code into which the contents of the authentication site address 13B and the program identifying data 13D are enclosed (step S11). Here, it is assumed that, by way of an unillustrated user interface, the subscriber can freely switch between the display of one and the other.

An example of how the QR code is displayed is shown in FIG. 7. As shown there, the QR code 17 is displayed not alone but along with one of a plurality of images (notification images) previously stored, as guides to pay programs, in the reception apparatus 3. Which pay program guide to display is determined based on the notification image selection data 13C being received.

Moreover, when a pay program is being received, the reception apparatus 3 watches for the entry of the key data (descrambling key) for descrambling the scrambling (step S12). Incidentally, once the key data is entered, such watching may be ended, and the above-mentioned display of the QR code 17 may also be ended.

Meanwhile, the mobile phone 4 watches for the transmission of the key data from the communication server 5 (step S21) and the acquisition of the QR code 17 by the photographing portion 42 (step S23). In this state, when the subscriber makes the mobile phone 4 acquire the QR code 17 displayed in step S11 (“Y” (yes) in step S23), the mobile phone 4 decodes the contents of the QR code 17, and accesses the communication server at the thereby acquired address (step S24).

Between steps S23 and S24, the subscriber may be given the choice of whether or not to accept the access to the authentication site, for example, with a display as shown in FIG. 8 presented on the mobile phone 4. Here, if the subscriber rejects access, the data of the QR code 17 is discarded, and the flow returns to step S21.

After step S24, the mobile phone 4 transmits its own ID data to the communication server 5, and requests the communication server 5 to transmit the key data to the mobile phone 4 (or the mail server or the like serving the mobile phone 4) (step S25).

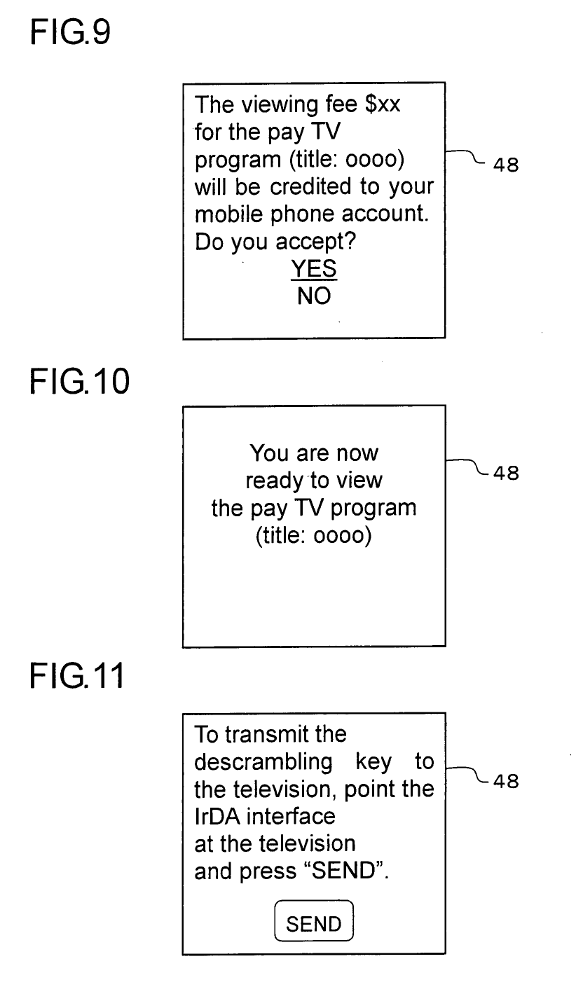

Between steps S24 and S25, the subscriber may be asked about his intention to pay the viewing charge etc., for example, with a display as shown in FIG. 9 presented on the mobile phone 4. Here, if the subscriber does not intend to pay the viewing charge or view the pay program, the flow does not proceed to step S25.

Meanwhile, the communication server 5 watches for a request from the mobile phone 4 to send the key data (step S31). Thus, if such a request is made in step S25(“Y” in step S31), the communication server 5 acquires the ID data of the mobile phone, and transmits the key data to the mobile phone 4 (or the mail server or the like serving the mobile phone 4) (step S32).

If the key data is transmitted in step 32 (“Y” in step S21), the mobile phone 4 receives the key data (step S22). Here, the mobile phone 4 may present a display as shown in FIG. 10 to notify the subscriber of the current state. The mobile phone 4 may thereafter further present a display as shown in FIG. 11 to prompt the subscriber to transmit the key data to the reception apparatus 3.

A program that makes the mobile phone 4 present a display as shown in FIG. 9 may previously be stored in the communication server 5 so that, when accessed by the mobile phone 4, the communication server 5 transmits the program to the mobile phone 4.

After the mobile phone 4 has acquired the key data, when the subscriber enters the key data into the reception apparatus 3 by way of the IrDA interfaces (“Y” in step S12), the reception apparatus 3 thereafter performs descrambling using the key data on the scrambling done on the video data of the pay program (step S13). As a result, if the key data is authentic, the scrambling is descrambled, allowing the contents of the pay program to be outputted as normal video.

On the other hand, based on the ID data acquired from the mobile phone 4, the pay program provider demands the telephone company with which the mobile phone 4 is in a contract to pay the viewing charge of the pay program. In response to the demand, the telephone company pays the viewing charge on behalf of the subscriber, and deducts the due amount from the subscriber's bank account.

The sequence of processing described above enables the subscriber to view the pay program. Here, for the subscriber to be able to view the pay program, he has only to do the following: making the mobile phone 4 read the QR code from the reception apparatus 3; making the mobile phone 4 access the communication server 5 to acquire the key data; and entering the key data into the reception apparatus 3. Thus, even with no viewing contract signed with the program provider beforehand, the subscriber can view the pay program without a long wait.

The pay program provider, on their part, can acquire the ID data of the mobile phone 4 owned by the subscriber, and thus, even with no program viewing contract signed with the subscriber beforehand, the pay program provider can easily collect the viewing charge. Specifically, since the ID data enables the pay program provider to identify the subscriber to the pay program and the telephone company with which the subscriber is in a contract, the pay program provider can easily collect the viewing charge even after the subscriber has viewed the pay program.

In this embodiment, it is assumed that the reception apparatus 3 handles pay programs whose video data has been scrambled. Instead, or in addition, the very displaying of video data on the screen may be restricted. For example, the key data may be incorporated also in the control data 13 so that, unless the key data transmitted from the mobile phone 4 coincides with it, the displaying of the video data on the screen is not performed.

### Embodiment 2

Next, a second embodiment of the present invention will be described. This embodiment is basically the same as Embodiment 1 except in the contents of the stream data transmitted from the television broadcast station 2 and in how the reception apparatus 3 displays pay program guides. Accordingly, no overlapping description will be repeated.

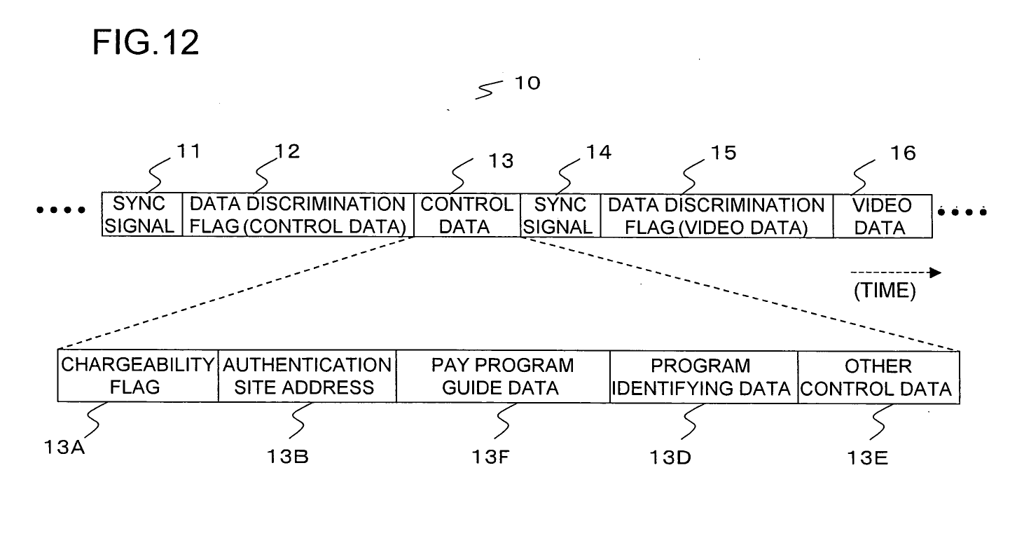

The contents of the stream data in this embodiment are shown in FIG. 12. As shown there, the stream data 10 here differs from that in Embodiment 1 in that, in place of the notification image selection data 13C, pay program guide data 13F is inserted. This pay program guide data 13F corresponds to the data for displaying pay program guides in Embodiment 1.

In Embodiment 1, a plurality of sets of data for displaying pay program guides have previously been stored in the reception apparatus 3, and one of them is displayed based on the contents of the notification image selection data 13C. In contrast, in this embodiment, the very data for displaying pay program guides is received from the television broadcast station 2.

Accordingly, in this embodiment, the control data 13 occupies an increased proportion of the stream data 10 in exchange for increased freedom in the contents of pay program guides. This makes it possible to display more accurate and more detailed pay program guides according to the contents and type of programs.

### Embodiment 3

Next, a third embodiment of the present invention will be described. This embodiment is basically the same as Embodiment 1 except that the key data is encrypted. Accordingly, no overlapping description will be repeated.

In this embodiment, the key data that is transmitted from the mobile phone to the reception apparatus by infrared communication is subjected to encryption exploiting the method of public-key cryptography. Public-key cryptography uses a public key and a private key that form a pair, and relies on the principle that data encrypted using the public key can only be decrypted using the corresponding private key. One example of a method exploiting public-key cryptography is the RSA algorithm, which depends on the difficulty of prime factorization.

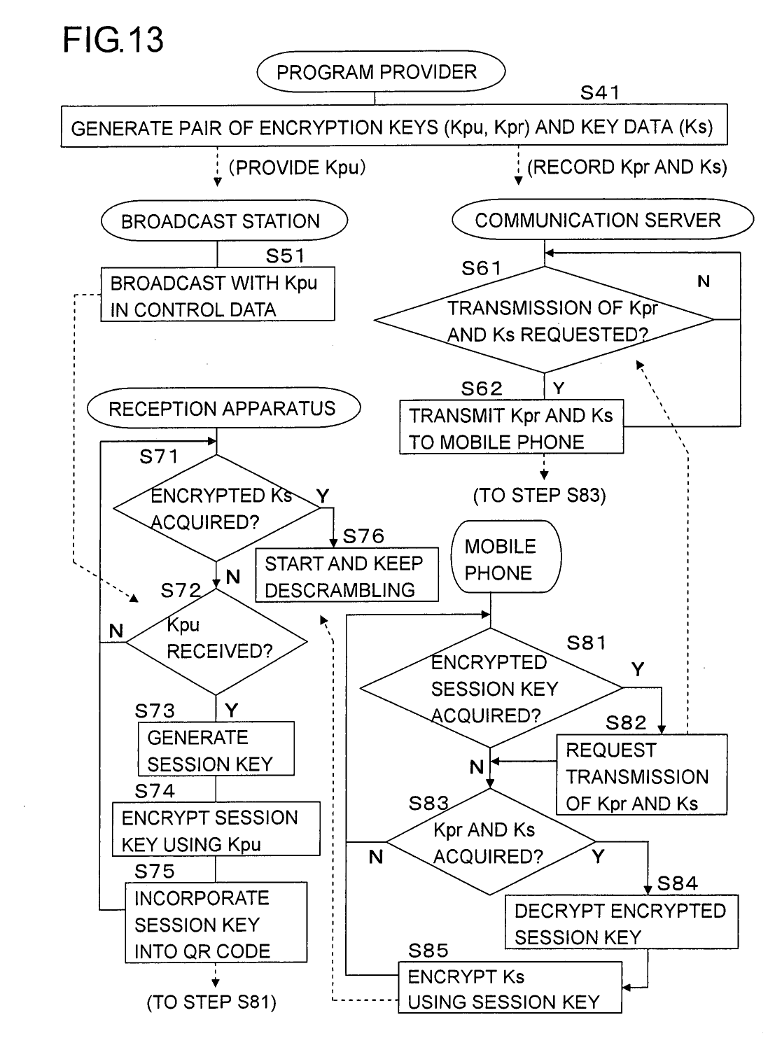

Now, with reference to the flow chart in FIG. 13, the processing performed in this embodiment will be described. Beforehand, the program provider generates a public key (hereinafter also referred to as “Kpu”) and a private key (hereinafter also referred to as “Kpr”) that form a pair, and also generates key data (hereinafter also referred to as “Ks”) with which the scrambling done on the video data can be descrambled. The program provider provides Kpu for the television broadcast station 2, and stores Kpr and Ks in the communication server (step S41).

The television broadcast station 2 then transmits broadcast with Kpu contained in the control data 13 (step S51). On the other hand, the communication server watches for a request from the mobile phone to transmit Kpr and Ks (S61), and, if such a request arises, the communication server transmits Kpr and Ks to the mobile phone (step S62).

When the reception apparatus 3 receives Kpu from the television broadcast station 2 (step S72), it generates a session key (random number) (step S73). The reception apparatus 3 then encrypts the session key with Kpu (step S74), and incorporates the encrypted session key into the QR code 17 (step S75).

The encrypted session key is acquired by the mobile phone 4 when it reads the QR through the photographing portion 42 (“Y” in step S81). Thereafter, when accessing the communication server 5, the mobile phone 4 requests it to transmit Kpr and Ks (step S82). In response, as described above, the communication server transmits Kpr and Ks to the mobile phone 4 (step S62).

Here, the communication (steps S82 and S62) between the mobile phone 4 and the communication server 5 is performed by use of the SSL (secure socket layer) protocol for enhanced safety. Incidentally, as in Embodiment 1, during this communication, the communication server 5 acquires the ID data of the mobile phone.

On completion of step S62, the mobile phone 4 has acquired the session key encrypted with Kpr, along with Kpu and Ks. Thus, the mobile phone 4 then first, using Kpu, undoes (decrypts) the encryption done on the session key (step S84). Thereafter, using the decrypted session key, the mobile phone 4 encrypts Ks (step S85).

When the encrypted Ks is transmitted to the reception apparatus 3 by infrared communication 8 (“Y” in step S71), the reception apparatus decrypts it and acquires Ks; thereafter, using Ks, the reception apparatus descrambles the scrambling done on the video signal (step S76). Incidentally, since the session key is generated by the reception apparatus 3 itself, so long as the encoding and decoding performed by the reception apparatus 3 and the mobile phone 4 match, the reception apparatus 3 can decrypt the encryption done on Ks. The session key may be generated newly every time it is necessary (for example, every time a set of transmission and reception of a session key is performed). This leads to higher safety.

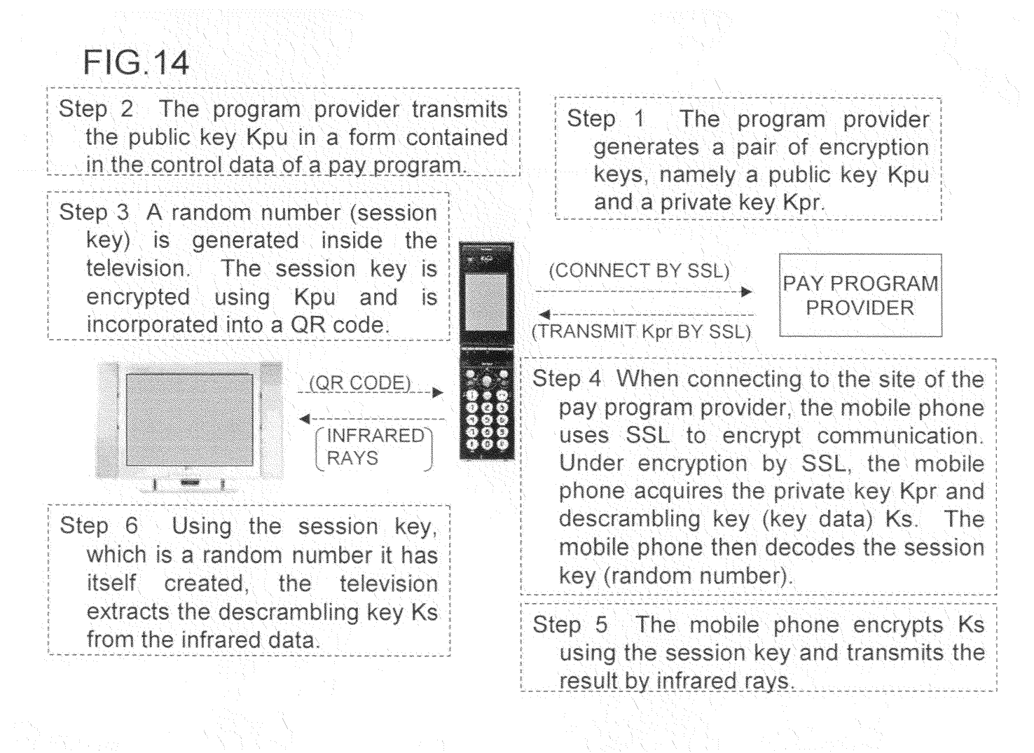

As described above, when the key data is transmitted from the mobile phone 4 to the reception apparatus 3 by infrared communication, it is encrypted using the session key. This prevents illicit acquisition of the key data by use of, for example, a remote control with a learning capability. In addition, the session key incorporated in the QR code is encrypted using Kpu, and this prevents illicit acquisition of the session key. An outline of the sequence of processing described above is shown in FIG. 14.

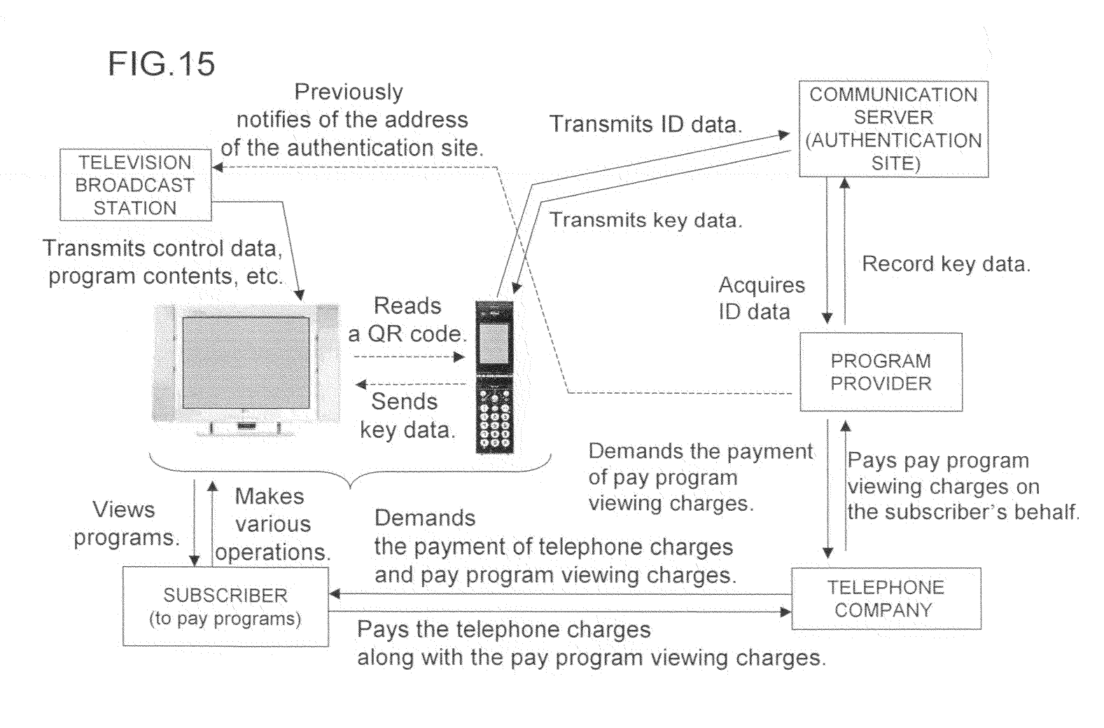

Summary: An outline of the configuration and processing in the embodiments of the present invention described above is shown, in a simplified form, in FIG. 15. As shown there, with the pay program providing system 1, the reception apparatus 3 displays the video data of a pay program on the screen (or descrambles the scrambling done on the video data of a pay program) only when predetermined key data is entered. Thus, by properly managing the key data, viewing restrictions can be placed on the pay program. Moreover, the communication server 5 transmits the key data to the mobile phone 4 that has transmitted the ID data thereof, or the like. Thus, by acquiring the ID data, the pay program provider, which administrates the communication server, can easily identify or otherwise manage subscribers.

Moreover, the communication server 5 has only to transmit the key data to the mobile phone that has transmitted the ID data thereof. Thus, the key data can be transmitted comparatively quickly. Accordingly, the key data needed to view the pay program can be sent to a subscriber quickly. In this way, it is possible to realize a pay program providing system that can quickly enable subscribers to view pay broadcast at their request to do so but that nevertheless allows program providers to identify subscribers easily.

The embodiments by way of which the present invention has been described hereinbefore are in no way meant to limit how it is practiced, and the present invention may be practiced with any modifications and variations made within its spirit. Moreover, different features of different embodiments may be combined together unless they conflict.

With the pay program providing system according to the present invention described above by way of embodiments, the television broadcast reception apparatus displays the video data of a pay program on the screen (or descrambles the scrambling done on the video data of a pay program) only when predetermined key data is entered. Thus, by properly managing the key data, viewing restrictions can be placed on the pay program. Moreover, the communication server transmits the key data to the communication terminal that has transmitted the ID data thereof or to a communication device that the communication terminal can access. Thus, by acquiring the ID data, the administrator of the communication server can easily identify or otherwise manage subscribers.

Moreover, the communication server has only to transmit the key data to the communication terminal that has transmitted the ID data thereof, or the like. Thus, the key data can be transmitted comparatively quickly. Accordingly, the key data needed to view the pay program can be sent to a subscriber quickly. In this way, it is possible to realize a pay program providing system that can quickly enable subscribers to view pay broadcast at their request to do so but that nevertheless allows program providers to identify subscribers easily.

Moreover, with the television broadcast receiving apparatus according to the present invention, it is possible to realize a television broadcast reception apparatus that is suitable for use in the pay program providing system described above.

1. A pay program providing system comprising:
a television broadcast reception apparatus receiving video data of a pay program and address data for accessing a predetermined communication server and displaying the address data on a screen;
a communication terminal acquiring the address data displayed on the screen and accessing the communication server; and
the communication server, when accessed, communicating with the communication terminal, the pay program providing system making the television broadcast reception apparatus display the video data of the pay program on the screen,
wherein the television broadcast reception apparatus displays the video data only when predetermined key data is entered, the communication terminal transmits ID data thereof to the communication server, the communication server transmits the key data to the communication terminal that has transmitted the ID data thereof or to a communication device that the communication terminal can access, and the communication terminal acquires the key data and outputs the key data to the television broadcast reception apparatus.

2. A pay program providing system comprising:
a television broadcast reception apparatus receiving video data of a pay program having undergone scrambling and address data for accessing a predetermined communication server and displaying the address data on a screen;
a communication terminal acquiring the address data displayed on the screen and accessing the communication server; and
the communication server, when accessed, communicating with the communication terminal, the pay program providing system making the television broadcast reception apparatus display the video data of the pay program on the screen,
wherein the scrambling can be descrambled by descrambling using predetermined key data, the television broadcast reception apparatus performs the descrambling and displays the video data only when the key data is entered, the communication terminal transmits ID data thereof to the communication server, the communication server transmits the key data to the communication terminal that has transmitted the ID data thereof or to a communication device that the communication terminal can access, and the communication terminal acquires the key data and outputs the key data to the television broadcast reception apparatus.

3. The pay program providing system according to claim 1, wherein the television broadcast reception apparatus comprises a QR code generating portion generating, based on the received address data, a QR code (a registered trademark of Denso Wave Incorporated) into which contents of the address data are encoded and displays the QR code as the address data on the screen.

4. The pay program providing system according to claim 3, wherein the television broadcast reception apparatus also receives program identifying data indicating a type of the pay program, and the QR code generating portion generates, based on the received address data and the program identifying data, a QR code into which contents of the address data and the program identifying data are encoded.

5. The pay program providing system according to claim 3, wherein the communication terminal comprises a data acquiring portion photographing the QR code displayed on the screen and acquiring the data encoded into the QR code.

6. The pay program providing system according to claim 1, wherein the television broadcast reception apparatus also receives chargeability identifying data indicating whether or not the program is a pay program and checks whether or not the program is a pay program based on the chargeability identifying data so that, only if the program is a pay program, the television broadcast reception apparatus displays the address data on the screen.

7. The pay program providing system according to claim 6, wherein the television broadcast reception apparatus comprises a notification image display portion that the television broadcast reception apparatus, on finding the program to be a pay program, makes display a notification image on a screen to notify a subscriber that the program is a pay program.

8. The pay program providing system according to claim 7, wherein the television broadcast reception apparatus comprises a notification image storage portion storing a plurality of types of the notification image, and the notification image display portion displays one of the plurality of types of the notification image on the screen.

9. The pay program providing system according to claim 8, wherein the television broadcast reception apparatus also receives notification image selection data indicating which of the plurality of types of the notification image to display, and the notification image display portion decides which of the types of the notification image to display on the screen based on the notification image selection data.

10. The pay program providing system according to claim 7, wherein the television broadcast reception apparatus also receives data of the notification image, and the notification image display portion displays the notification image on the screen.

11. The pay program providing system according to claim 4, wherein the communication terminal transmits the program identifying data to the communication server, and the communication server transmits predetermined transmission data stored previously therein to the communication terminal according to the program identifying data received therefrom.

12. The pay program providing system according to claim 11, wherein the transmission data contains data for notifying a subscriber of the fact that the program is a pay program along with a title and a viewing charge of the pay program.

13. The pay program providing system according to claim 11, wherein the transmission data contains data for notifying a subscriber that the program is a pay program and that a viewing charge of the pay program can be paid by a charge collection service for the communication terminal.

14. The pay program providing system according to claim 4, wherein the communication terminal transmits the program identifying data to the communication server, the communication server transmits a program stored previously therein to the communication terminal according to the program identifying data received therefrom, and the program is for making the communication terminal display a predetermined image on a screen.

15. The pay program providing system according to claim 1, wherein the communication terminal and the television broadcast reception apparatus are provided with infrared communication means for communicating with each other by infrared communication, and the communication terminal transmits the key data to the television broadcast reception apparatus by the infrared communication means.

16. The pay program providing system according to claim 1, wherein the communication server encrypts the key data by encryption that can be decrypted by predetermined decryption, and the television broadcast reception apparatus acquires the key data by performing the decryption.

17. A method for use in the pay program providing system according to claim 1 to provide the pay program, the method comprising:
a first step in which the television broadcast reception apparatus receives the address data and displays the address data on the screen;
a second step in which the communication terminal acquires an image representing the address data displayed on the screen and accesses the communication server;
a third step in which the communication terminal transmits the ID data thereof to the communication server;
a fourth step in which the communication server transmits the key data to the communication terminal that has transmitted the ID data thereof or to a commutation device that the communication terminal can access;
a fifth step in which the communication terminal acquires the key data and outputs the key data to the television broadcast reception apparatus; and
a sixth step in which the television broadcast reception apparatus acquires the key data.

18. A pay program providing system comprising:
a television broadcast station broadcasting video data of a pay program and address data for accessing a predetermined communication server;
a television broadcast reception apparatus receiving the video data and the address data and displaying the address data on a screen;
a communication terminal acquiring the address data displayed on the screen and accessing the communication server; and
the communication server, when accessed, communicating with the communication terminal, the pay program providing system making the television broadcast reception apparatus display the video data of the pay program on the screen,
wherein the television broadcast reception apparatus displays the video data only when predetermined key data is entered, the communication terminal transmits ID data thereof to the communication server, the communication server transmits the key data to the communication terminal that has transmitted the ID data thereof or to a communication device that the communication terminal can access, and the communication terminal acquires the key data and outputs the key data to the television broadcast reception apparatus.

19. A pay program providing system comprising:
a television broadcast station broadcasting video data of a pay program having undergone scrambling and address data for accessing a predetermined communication server;
a television broadcast reception apparatus receiving the video data and the address data and displaying the address data on a screen;
a communication terminal acquiring the address data displayed on the screen and accessing the communication server; and
the communication server, when accessed, communicating with the communication terminal, the pay program providing system making the television broadcast reception apparatus display the video data of the pay program on the screen,
wherein the scrambling can be descrambled by descrambling using predetermined key data, the television broadcast reception apparatus performs the descrambling and displays the video data when the key data is entered, the communication terminal transmits ID data thereof to the communication server, the communication server transmits the key data to the communication terminal that has transmitted the ID data thereof or to a communication device that the communication terminal can access, and the communication terminal acquires the key data and outputs the key data to the television broadcast reception apparatus.

20. A method for use in the pay program providing system according to claim 18 to provide the pay program, the method comprising:
a first step in which the television broadcast station broadcasts the video data of the pay program and the address data;
a second step in which the television broadcast reception apparatus receives the address data and displays the address data on the screen;
a third step in which the communication terminal acquires an image representing the address data displayed on the screen and accesses the communication server;
a fourth step in which the communication terminal transmits the ID data thereof to the communication server;
a fifth step in which the communication server transmits the key data to the communication terminal that has transmitted the ID data thereof or to a commutation device that the communication terminal can access;
a sixth step in which the communication terminal acquires the key data and outputs the key data to the television broadcast reception apparatus; and
a seventh step in which the television broadcast reception apparatus acquires the key data.

21. A television broadcast reception apparatus receiving television broadcast containing-video data of a pay program, address data for accessing a predetermined communication server, and chargeability identifying data indicating whether or not the program is a pay program, and displaying the video data on a screen, the television broadcast reception apparatus comprising:
a chargeability checking portion checking, based on the chargeability identifying data, whether or not the program is a pay program;
a QR code generating portion generating, based on the address data, a QR code into which contents of the address data are encoded; and
a QR code display portion displaying the QR code on the screen when the chargeability checking portion finds the program to be a pay program.

22. The television broadcast reception apparatus according to claim 21, further comprising:
a notification image display portion that the television broadcast reception apparatus, on finding the program to be a pay program, makes display a notification image on a screen to notify a subscriber that the program is a pay program.

23. The television broadcast reception apparatus according to claim 22, further comprising:
a notification image storage portion storing a plurality of types of the notification image, wherein the notification image display portion displays one of the plurality of types of the notification image on the screen.

24. The television broadcast reception apparatus according to claim 23, wherein the television broadcast reception apparatus also receives notification image selection data indicating which of the plurality of types of the notification image to display, and the notification image display portion decides which of the types of the notification image to display on the screen based on the notification image selection data.

25. The television broadcast reception apparatus according to claim 23, wherein the television broadcast reception apparatus also receives data of the notification image, and the notification image display portion displays the notification image on the screen.
